(19) United States
(12) Patent Application Publication
(10) Pub. No.: US 2026/0212491 A1
(43) Pub. Date: Jul. 23, 2026

(54) INFORMATION PROCESSING APPARATUS, INFORMATION PROCESSING METHOD, AND STORAGE MEDIUM STORING PROGRAM

(71) Applicant: CANON KABUSHIKI KAISHA, Tokyo (JP)

(72) Inventor: MINORU OHKOBA, Chiba (JP)

(21) Appl. No.: 19/442,792

(22) Filed: Jan. 7, 2026

(30) Foreign Application Priority Data
Jan. 20, 2025 (JP) 2025-007908

(51) Int. Cl. G06T 7/00; G06T 7/60

(52) U.S. Cl. CPC G06T 7/001; G06T 7/0006; G06T 7/60; G06T 2207/20081; G06T 2207/20084; G06T 2207/30144; G06T 2207/30156; G06T 2207/30201

(57) ABSTRACT

An information processing apparatus includes at least one processor and at least one memory that is in communication with the at least one processor. The at least one memory stores instructions for causing the at least one processor and the at least one memory to acquire a feature amount indicating a degree of deviation of a captured image of an object from a reference, perform a first quantification process based on a predetermined rule process, perform a second quantification process based on a machine learning model trained using an image having a large degree of deviation from the reference, and adopt either of the first and second quantification processes based on the feature amount.

### BACKGROUND

### Field of the Technology

The present disclosure relates to an information processing technique based on an image.

### Description of the Related Art

Conventionally, as an inspection method used to determine pass or fail of an inspection target object, an inspection method for sequentially performing a normal inspection process using a feature amount extracted from a captured image of an inspection target object and an inspection process using a machine learning model based on deep learning is known. Japanese Patent Laid-Open No. 2020-187656 describes a technique for extracting a feature amount from a captured image of an inspection target object, determining pass or fail of the inspection target object by a normal inspection process based on the result of comparing the feature amount and a threshold, and if pass or fail is still not determined, determining pass or fail based on a machine learning model. In Japanese Patent Laid-Open No. 2020-187656, the color, the edge, the position, and the like of the inspection target object appearing in the captured image are acquired as feature amounts, and the feature amounts are set as quantitative values for use in determining pass or fail of the inspection target object.

### SUMMARY

Embodiments of the present disclosure are directed to acquisition of an appropriate quantitative value.

According to an aspect of the present disclosure, an information processing apparatus includes at least one processor and at least one memory that is in communication with the at least one processor. The at least one memory stores instructions for causing the at least one processor and the at least one memory to acquire a feature amount indicating a degree of deviation of a captured image of an object from a reference, perform a first quantification process based on a predetermined rule process, perform a second quantification process based on a machine learning model trained using an image having a large degree of deviation from the reference, and adopt either of the first and second quantification processes based on the feature amount.

Features of various embodiments will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of an information processing apparatus.

FIG. 2 is a flowchart illustrating a flow of information processing according to a first embodiment.

FIGS. 3A to 3F are diagrams illustrating examples of a captured image, a feature amount, and a quantitative value.

FIG. 4 is a diagram illustrating examples of quantitative values obtained by first and second quantification processes.

FIGS. 5A to 5D are diagrams illustrating examples of captured images as inspection targets of orange peel.

FIG. 6 is a flowchart illustrating a flow of information processing according to a second embodiment.

FIG. 7 is a diagram used to describe a quantification region and a wide region according to a third embodiment.

FIG. 8 is a flowchart illustrating a flow of information processing according to the third embodiment.

FIGS. 9A and 9B are diagrams used to describe a wide region according to a variation of the third embodiment.

FIG. 10 is a flowchart illustrating a flow of information processing according to a fourth embodiment.

FIG. 11 is a diagram illustrating relationships between feature amounts and quantification processes according to a sixth embodiment.

### DESCRIPTION OF THE EMBODIMENTS

Embodiments according to the present disclosure will be described below with reference to the drawings. The following embodiments do not limit every embodiment, and not all the combinations of a plurality of features described in the present embodiments are essential for a method for solving the issues in the present disclosure. The plurality of features may be optionally combined together. The configurations of the embodiments can be appropriately modified or changed depending on the specifications of an apparatus to which the present disclosure is applied, or various conditions (the use conditions and the use environment). In the following embodiments, the same or similar components and processing steps are not redundantly described.

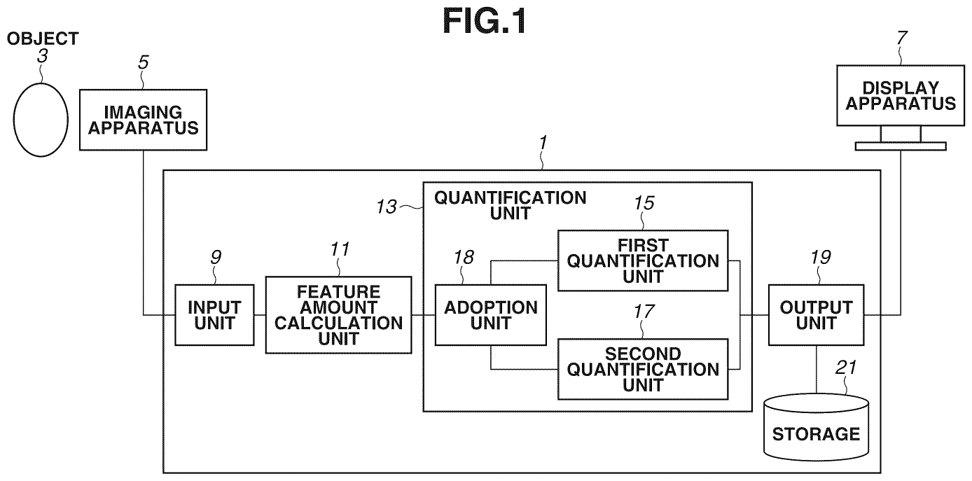

FIG. 1 is a block diagram illustrating an example of the configuration of an information processing apparatus 1 according to each of the following embodiments.

FIG. 1 also illustrates an imaging apparatus 5 and a display apparatus 7 as external related apparatuses other than the information processing apparatus 1 to describe the relationships between the functions of these apparatuses and the functions of the information processing apparatus 1. FIG. 1 also illustrates an object 3 to describe information processing performed by the information processing apparatus 1.

Based on a captured image acquired by the imaging apparatus 5, the information processing apparatus 1 generates and outputs a quantitative value represented by a numerical value. For example, in a case where the information processing apparatus 1 according to the present embodiment evaluates an inspection target based on the quantitative value, the information processing apparatus 1 according to the present embodiment can be referred to as an “evaluation apparatus”. In a case where the information processing apparatus 1 according to the present embodiment determines pass or fail of the inspection target based on the quantitative value, the information processing apparatus 1 according to the present embodiment can also be referred to as an “inspection apparatus”. That is, the information processing apparatus 1 according to the present embodiment may function as the evaluation apparatus, or may function as the inspection apparatus, or may have both functions of the evaluation apparatus and the inspection apparatus.

The object 3 may be a target object as a target of an evaluation or an inspection, or may be a composition or a design on which an image input to the information processing apparatus 1 is based.

For example, in a case where the information processing apparatus 1 acquires a quantitative value for use in evaluating the performance of a camera, the object 3 is a target object, such as a person, a thing, or the like, a particular composition of a three-dimensional object, a two-dimensional design for quantifying the contrast characteristic or the resolution, or the like captured by the camera as the evaluation target. Examples of the two-dimensional design for quantifying the contrast characteristic or the resolution include a slanted edge chart, a hyperbolic chart, a circular zone plate (CZP) chart, and the like.

For example, in a case where the information processing apparatus 1 acquires a quantitative value for use in evaluating the performance of a printer, the object 3 is a two-dimensional chart or the like printed on a print medium, such as paper or the like, by the printer as the evaluation target.

For example, in a case where the information processing apparatus 1 acquires a quantitative value for use in evaluating the performance of the object 3 itself captured by a camera, the object 3 is the entirety of the object 3 including a change in the quantitative value. As an example, in a case where the state of a product on a production line is evaluated, the object 3 is all products moving down the production line. For example, in the case of an automobile production line, examples of the evaluation of the state of a product on the production line can include the evaluation of the appearance of an automobile, the evaluation of the paint state of the automobile, and the like. As a matter of course, these cases are merely examples, and any target object as an evaluation target can be the object 3.

The imaging apparatus 5 is a still camera, a video camera, a scanner, or the like and is an apparatus that converts light incident on an imaging element into digital two-dimensional data. As an example, in a case where the information processing apparatus 1 according to the present embodiment acquires a quantitative value for use in evaluating the characteristics of a camera, the two-dimensional design or the like for quantifying the contrast characteristic or the resolution is used as the object 3. Then, the information processing apparatus 1 performs quantification based on the difference between a design appearing in a captured image obtained by the imaging apparatus 5 that is the camera as the evaluation target capturing the design that is the object 3, and a two-dimensional design as a reference.

The display apparatus 7 displays the result of a quantification process performed by the information processing apparatus 1. If a product is monitored in a production site or the like, there is also a case where the display apparatus 7 displays the result of the quantification process in real time. A display of a personal computer (PC) may be substituted for the display apparatus 7. If the display of the result of the quantification process or the like does not require real time, the display apparatus 7 may not need to be connected to (or built into) the information processing apparatus 1, and the result of the quantification process may be saved in storage 21 within the information processing apparatus 1, an external recording device, or the like.

The information processing apparatus 1 according to the present embodiment may not only exist as an independent apparatus, such as the inspection apparatus, the evaluation apparatus, or the like, but also be included in, for example, a digital camera (an imaging apparatus), a scanner, a printer having a scanner function, or the like. The information processing apparatus 1 included in a printer having a scanner function can also be used to evaluate the print quality of the printer or the like.

As illustrated in FIG. 1, the information processing apparatus 1 according to the present embodiment includes an input unit 9, a feature amount calculation unit 11, a quantification unit 13, an output unit 19, and storage 21. The quantification unit 13 includes a first quantification unit 15, a second quantification unit 17, and an adoption unit 18.

The input unit 9 acquires a target image of a quantification process to be performed by the information processing apparatus 1 from outside.

Although in the present embodiment, an example is taken where the input unit 9 acquires as the target image a captured image captured by the imaging apparatus 5, for example, the target image may be an image read from external storage (not illustrated) or the like, or may be an image sent via a communication network or the like. The input unit 9 sends the acquired target image (the captured image from the imaging apparatus 5 in the present embodiment) to the feature amount calculation unit 11.

The feature amount calculation unit 11 acquires from the target image a feature amount as a basis for selecting which of a first quantification process by the first quantification unit 15 and a second quantification process by the second quantification unit 17 is to be adopted. In the present embodiment, the feature amount calculation unit 11 acquires a feature amount capable of indicating the degree of deviation between a predetermined reference image when the inspection or the evaluation is performed, and the captured image (the target image) acquired by the input unit 9. Specific examples of the feature amount will be described below.

The feature amount calculation unit 11 sends the captured image (the target image) sent from the input unit 9 and the feature amount acquired by the feature amount acquisition process to the quantification unit 13.

The quantification unit 13 includes two or more quantification modules that perform quantification processes. In the present embodiment, the quantification unit 13 includes as the quantification modules the first quantification unit 15 that performs a first quantification process according to a rule process determined in advance, and the second quantification unit 17 that performs a second quantification process using a machine learning model.

Based on the feature amount acquired by the feature amount calculation unit 11, the adoption unit 18 selects which of the first and second quantification processes is to be adopted. For example, if the feature amount indicating the degree of deviation (in other words, the amount of deviation) between the reference image and the target image is less than a predetermined first threshold, the adoption unit 18 determines that the first quantification process is to be adopted. If, on the other hand, the feature amount is greater than or equal to the first threshold, the adoption unit 18 determines that the second quantification process is to be adopted.

The first quantification unit 15 is a quantification module that performs the first quantification process according to the rule process determined in advance. The first quantification process is a quantification process based on the rule process determined in advance, i.e., a quantification process based on a calculation rule defined in advance. The first quantification unit 15 performs the first quantification process on the target image of the quantification process and outputs a quantitative value that is the result of the quantification process. Examples of the quantitative value include a gradation value itself, and a color gamut, a contrast ratio, acutance, granularity, glossiness, and the like obtained by performing a predetermined calculation on the gradation value, and further include values defined by standards, such as the International Organization for Standardization (ISO) standard, Japanese Industrial standards (JIS), and the like, values obtained by performing predetermined conversion on these values, and the like.

The second quantification unit 17 is a quantification module that performs the second quantification process using the machine learning model. The machine learning model is a trained model obtained by performing machine learning using a plurality of images including many exception images that are not an ideal image satisfying a precondition determined in advance.

The plurality of images used in the machine learning may include not only actual images but also images obtained by creating, in a simulated manner, exceptional images assumed in a case where many images are captured. The machine learning model may be any model including a superordinate concept, such as supervised learning, unsupervised learning, or reinforcement learning. The machine learning may be a neural network, a recurrent neural network (RNN), a convolutional neural network (CNN), deep learning, an autoencoder, a generative adversarial network (GAN), or the like to which the technique of supervised learning, unsupervised learning, reinforcement learning, or the like is applied. The second quantification unit 17 performs the second quantification process on the target image of the quantification process and outputs a quantitative value indicating the result of the quantification process. In the first quantification process, in a case where the target image is an exception image that is not the ideal image satisfying the precondition determined in advance, an incorrect quantitative value may be output. Thus, the second quantification process is performed on the target image that may not be able to be quantified by the first quantification process.

Although FIG. 1 illustrates an example of a configuration in which, in the quantification unit 13, the adoption unit 18 is provided at a stage prior to the first quantification unit 15 and the second quantification unit 17, and the adoption unit 18 selects which of the first and second quantification processes is to be performed, some embodiments of the present disclosure are not limited to this.

For example, the adoption unit 18 may be provided at a stage subsequent to the first quantification unit 15 and the second quantification unit 17, both the first quantification unit 15 and the second quantification unit 17 may perform quantification processes, and based on the feature amount, the adoption unit 18 may select which of quantitative values as the results of the quantification processes is to be adopted.

The output unit 19 receives the quantitative value as the result of the quantification process performed by the quantification unit 13 and outputs the quantitative value to either or both of the display apparatus 7 and the storage 21. The output unit 19 may output either or both of the target image and the feature amount with the quantitative value as the result of the quantification process.

In the example of FIG. 1, the storage 21 is provided within the information processing apparatus 1, but may be an external memory or the like attached to the information processing apparatus 1.

The components from the input unit 9 to the output unit 19 may be provided as physical independent components on an electric substrate, or for example, may be achieved as operation modules on software of a PC or the like.

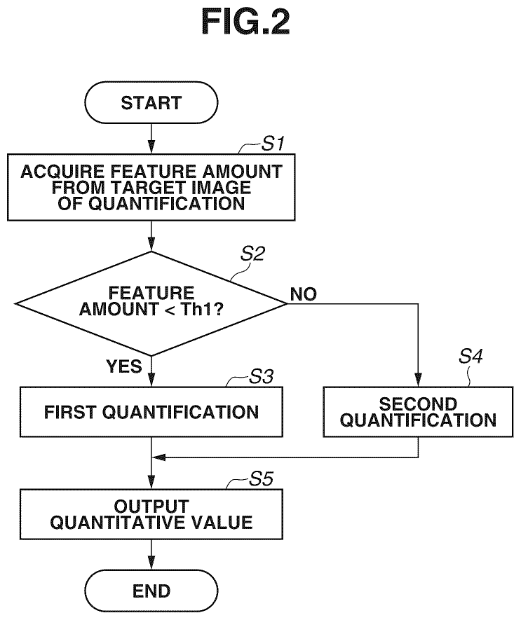

FIG. 2 is a flowchart illustrating the schematic flow of information processing performed by the information processing apparatus 1 according to the present embodiment. In the following flowcharts, the same processing steps are designated by the same reference signs, and are not redundantly described.

First, in step S1, the input unit 9 acquires a target image of quantification, and the feature amount calculation unit 11 acquires a feature amount from the target image.

Next, in step S2, the adoption unit 18 determines whether the feature amount is less than a first threshold (hereinafter, a “threshold Th1”). Then, if the adoption unit 18 determines that the feature amount is less than the threshold Th1 (Yes in step S2), the processing proceeds to step S3. If, on the other hand, the adoption unit 18 determines that the feature amount is greater than or equal to the threshold Th1 (No in step S2), the processing proceeds to step S4. Alternatively, steps S3 and S4 may be switched according to a configuration in which the present embodiment is employed.

In step S3, the first quantification unit 15 executes the first quantification process on the target image (a captured image). Then, after step S3, the processing proceeds to step S5.

On the other hand, in step S4, the second quantification unit 17 executes the second quantification process on the target image (the captured image). Then, after step S4, the processing proceeds to step S5.

In step S5, the output unit 19 outputs a quantitative value obtained by the quantification process by the first quantification unit 15 or the second quantification unit 17 to either or both of the storage 21 and the display apparatus 7.

Next, the feature amount and the threshold Th1 are described taking specific examples.

For example, if a quantitative value corresponding to a case where a particular evaluation or inspection is performed is acquired, an object as a target is fixed.

A change in the quantitative value includes “a change in the quantitative value reflecting the content of a phenomenon that should be measured” and “a change in the quantitative value not reflecting the content of a phenomenon that should be measured”.

In the present embodiment, the “feature amount” refers to “the amount of deviation of an image from a reference”, and particularly, refers to an amount that causes “a change in the quantitative value not reflecting the content of a phenomenon that should be measured”. The feature amount indicating “the amount of deviation of an image from a reference” is broadly divided into two types. There are a feature amount in “a case where another thing overlaps the object” and a feature amount in “a case where the shape of the object changes”. According to a content that should be quantified, there is a case where either one of the two types of feature amounts occurs, or there is a case where both types of feature amounts occur.

For example, in a case where the resolution of an apparatus as an evaluation target such as a camera, a printer, or the like is evaluated, for example, a CZP chart is used as the object 3, and the CZP chart is output through the apparatus as the evaluation target.

For example, in a case where the resolution of a camera as an evaluation target is evaluated, an image obtained by the imaging apparatus 5 that is the camera as the evaluation target capturing a CZP chart is input as a target image to the information processing apparatus 1 according to the present embodiment. Then, the information processing apparatus 1 sets an ideal CZP chart image as a reference image and quantifies the degree of decrease (the degree of change) in the contrast between the reference image and the target image obtained by the camera as the evaluation target capturing the CZP chart.

For example, in a case where the resolution performance of a printer as an evaluation target is evaluated, a print product obtained by the printer as the evaluation target printing a CZP chart is read by, for example, the imaging apparatus 5 composed of a scanner, and an image of the read print product is input as a target image to the information processing apparatus 1. Then, the information processing apparatus 1 quantifies the degree of decrease (or the rate of change) in the contrast between a CZP chart image as a reference image and the target image read by the scanner. The quantitative value in this case is the difference (or the ratio) between pixel values at particular coordinates.

As described above, the degree of decrease in the contrast is the quantitative value that should be evaluated, but a factor in a change in the quantitative value other than the degree of decrease in the contrast is, for example, a deviation from a composition. If there is a deviation from a composition or the like, for example, the quantitative value acquired by the first quantification process according to the rule process determined in advance is likely to be an inappropriate value. “Inappropriate” in this case means that, for example, the quantitative value acquired by the quantification process becomes a value that significantly deviates from a value estimated by eye by a person. For example, if there is a scratch, dirt, streak unevenness, or the like in the object 3 and a design locally changes, this also affects the feature amount acquired by the feature amount calculation unit 11. In a sense, the scratch, the dirt, the streak unevenness, or the like corresponds to “a case where another thing overlaps the object”. The CZP chart is an aggregate image of a plurality of concentric circles, and similar images are arranged in the circumferential direction. However, for example, if a foreign substance, a scratch, or the like overlaps the CZP chart, an outlier arises in values in the circumferential direction, and the dispersion of specific frequencies in the circumferential direction, the maximum value of the dispersion, or the like is acquired as the feature amount.

The threshold Th1 for the feature amount is a value that can be determined by comparing the quantitative value acquired by the rule process determined in advance and a true value. For example, the true value is obtained using a region where another thing does not overlap the object 3, or a region unaffected by another thing. It is possible to compare the thus obtained true value and the quantitative value acquired by the rule process determined in advance and determine a value at the boundary of accuracy as the threshold Th1. Alternatively, a value slightly away from the boundary of accuracy may be set as the threshold Th1.

In the above example, a case has been taken where the resolution of a camera is evaluated. Further, as another example, in a case where the focusing performance of the camera is evaluated, not a chart as described above but a natural thing, such as the face of a person or the like, is often used as the object 3. For example, if an image in which a grid obstacle (e.g., the strings of a badminton racket, the shadow of a netted fence, or the like) overlaps the front of the face is captured, a frequency characteristic as a factor in a particular shape can be set as a feature amount from a fast Fourier transform (FFT) image obtained by performing FFT on the image. In this case, for example, regarding the threshold Th1, there is a case where a true value of focus is obtained from the contrast of an image portion unaffected by the grid obstacle, or there is a case where a true value is obtained from an image obtained by subtracting specific frequency components from the FFT image and performing inverse FFT on the resulting image. Then, it is possible to compare the obtained true value and the quantitative value acquired by the rule process determined in advance and determine the threshold Th1 as the boundary of focus accuracy.

If a quantitative value for evaluating the performance of the camera is acquired, there is a certain degree of freedom between the object 3 and the camera. Thus, for example, not only is there “a case where another thing overlaps the object”, but there is also “a case where the shape of the object viewed by the camera changes”. As “a case where the shape of the object changes”, for example, a case where the object 3 that is a three-dimensional object faces in a direction other than the front surface of the camera or the like is assumed. In this case, the degree to which the object 3 faces in the direction other than the front surface is set as the feature amount. For example, if the object 3 is a face, collation using stereo matching on the face is performed, and the inaccuracy rate of the collation can be acquired as the feature amount. For example, in a case where the focusing of the camera is evaluated, regarding the threshold Th1, it is possible to quantify the degree of focusing in a visible portion in an image in which the inaccuracy rate is sufficiently low, set the quantified degree of focusing as a true value, compare the true value and the quantitative value acquired by the rule process determined in advance, and use a value at the boundary of accuracy as the threshold Th1 based on the result of the comparison.

Further, for example, there is also a case where “a case where the shape of the object changes” is caused by blur or defocus due to the movement of the object 3 or the imaging apparatus 5, a shift in the fixing of a device such as the imaging apparatus 5 or the like, a change in the curvature of the object 3 due to a change in the relative position between the object 3 and the imaging apparatus 5, or the like. In this case, the feature amount can be represented by the shape, the length, or the degree of curve (a coefficient when quadratic curve fitting is performed or the like) of the object 3, or the quantitative difference between a composition and a design or a shape. Also regarding the threshold Th1 in this case, it is possible to obtain a true value from a portion where a shift from the composition or the design is small, compare the true value and the quantitative value acquired by the rule process determined in advance, and use a value at the boundary of accuracy as the threshold Th1.

If the above examples are generalized, as described above, the “feature amount” refers to “the amount of deviation of an image from a reference”, and particularly, refers to an amount that causes “a change in the quantitative value not reflecting the content of a phenomenon that should be measured”. As described above, the feature amount is broadly divided into two types. There are a feature amount in “a case where another thing overlaps the object” and a feature amount in “a case where the shape of the object changes”. According to a content that should be quantified, there is a case where either of the two types of feature amounts occurs, or there is a case where both types of feature amounts occur. The threshold Th1 is determined as a range where the measurement accuracy is less than or equal to a certain value. That is, in “a case where another thing overlaps the object”, a true value is searched for in a portion unaffected by the overlap. In “a case where the shape of the object changes”, a true value is searched for in a region where the change is small. Then, each of the true values and the quantitative value acquired by the rule process determined in advance are compared with each other, and a value indicating the boundary of accuracy is set as a threshold. The above example of the acquisition of the feature amount and the above example of the determination of the threshold Th1 are merely examples, and are not limited to the above examples.

### First Embodiment

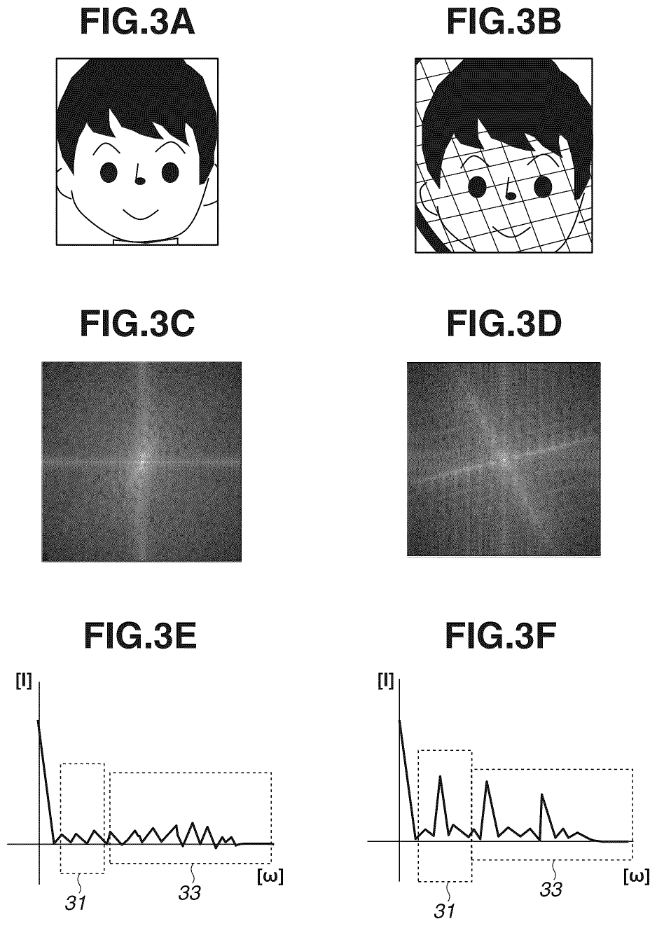

With reference to FIGS. 3A to 3F, FIG. 4, and FIGS. 5A to 5D, a first embodiment is described below.

A description is given taking a case where, when the face of a person is captured by focusing on, for example, the eyes of the face of the person, a grid obstacle (the strings of a badminton racket or the like) overlaps the front of the face, as an example of a case where a quantitative value for use in evaluating the focusing performance of a camera is acquired.

When the face of a person is captured, the degree to which the face is in focus is also termed the degree of focusing or the like. The degree of focusing is the resolution of high-frequency components and is generally represented by the integral value of the high-frequency region of an FFT image. If the integral value is great, this indicates that there are many high-frequency components. That is, based on the integral value of the high-frequency region of the FFT image, it is possible to find the degrees of sharpness of the edges of the boundaries of the eyes, the mouth, and the contour, which are characteristic parts of the face, and determine whether the face is in focus.

FIGS. 3A to 3F are diagrams illustrating the relationships between an image obtained by a camera that is an evaluation target of focusing performance capturing a particular object (the face of a person), a feature amount, and a quantitative value acquired by the rule process determined in advance (the first quantification process). FIG. 3A illustrates a captured image of the face of a person and illustrates an example of an image in which the degree of deviation between a reference image (an image as a reference in the state where an obstacle or the like is not present) and the captured image is small (the amount of deviation is small) because the face is in focus. On the other hand, FIG. 3B illustrates a captured image of the face of a person similar to that in FIG. 3A and illustrates an example of an image in which the degree of deviation (the amount of deviation) from the reference image is large because the face is in focus, but the strings of a badminton racket or the like overlap the front of the face. FIGS. 3A and 3B illustrate simplified diagrams of images used in actual experiment. Both images in FIGS. 3A and 3B are images in which the face portion is in focus, and the texture of the face is visible.

FIG. 3C illustrates an FFT image obtained by performing FFT on the image in FIG. 3A. FIG. 3D illustrates an FFT image obtained by performing FFT on the image in FIG. 3B. FIG. 3E is a simplified diagram obtained by converting a two-dimensional image from the center of the FFT image in FIG. 3C into a two-dimensional graph to facilitate the understanding of the frequency domain. Similarly, FIG. 3F is a simplified diagram obtained by converting a two-dimensional image from the center of the FFT image in FIG. 3D into a two-dimensional graph. In each of FIGS. 3E and 3F, the vertical axis represents intensity, and the horizontal axis represents frequency. In each of FIGS. 3E and 3F, a region 31 is a feature amount extraction frequency region, and a region 33 is a quantification frequency region.

In the case of a captured image in which the degree of deviation from the reference image is small, as illustrated in the example of FIG. 3A, a quantitative value for the focus of the face portion is obtained by acquiring an FFT image as illustrated in FIG. 3C and integrating high-frequency components of the FFT image. In an image in which the degree of deviation from the reference image is small and the resolution is high, as illustrated in FIG. 3A, the intensity of the high-frequency region remains high as illustrated in FIG. 3E, and high-frequency region components of the entire region are normalized to 6% to 10%.

In contrast, in the case of a captured image in which the degree of deviation from the reference image is large as illustrated in FIG. 3B because the image is captured in the state where a grid object such as the strings of a racket or the like overlaps the face, an FFT image is an image in which high-frequency components remain in a particular angular direction as illustrated in FIG. 3D. Thus, as illustrated in FIG. 3F, harmonics of specific frequency components remain, the quantification frequency region indicated by the region 33 is affected by the grid object, and the integral value of the quantification frequency region (the region 33) is extremely great. In this example, the proportion of the integral value to the entire region is 20%, for example. If, on the other hand, the grid object overlaps the face, a peak occurs in the low-frequency region according to the frequency of the grid.

Thus, in the present embodiment, a particular region is provided as the feature amount extraction frequency region (the region 31) in FIG. 3E or 3F in the low-frequency region, and the maximum value of the intensity in the particular region is used as the feature amount indicating the degree of deviation between the reference image and the captured image. Through use of such a value, the feature amount is an amount calculated so that there is a numerical difference between an image to which quantification based on the rule process determined in advance can be applied and an image to which quantification based on the rule process determined in advance cannot be applied.

Then, in the present embodiment, if the feature amount indicating the degree of deviation between the reference image and the captured image is less than the threshold Th1, it can be determined that the grid object or the like, such as the strings of a racket or the like, does not overlap the face. Thus, the first quantification unit 15 performs the first quantification process. If, on the other hand, the feature amount indicating the degree of deviation between the reference image and the captured image is greater than or equal to the threshold Th1, it can be determined that the grid object or the like overlaps the face. Thus, the second quantification unit 17 performs the second quantification process using the machine learning model. As the machine learning model in this example, a learning model subjected to supervised learning using as supervised data a quantitative value calculated from a region where harmonics of a grid or the like do not overlap the face in advance is used. That is, as a result of extracting the feature amount from the captured image in FIG. 3B and performing the second quantification process using the machine learning model, the quantitative value indicating the proportion of the feature amount to the entire region is 8.0% (a value between 6% and 10%). Thus, a value that matches a visual sense in a case where the face is in focus is successfully calculated.

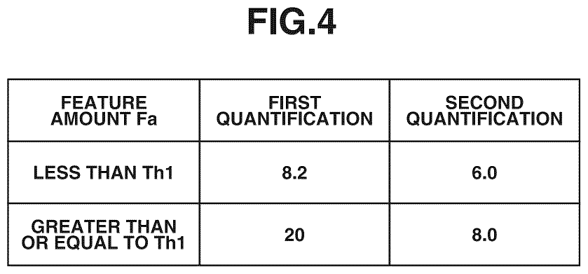

FIG. 4 is a diagram illustrating a table indicating a quantitative value in a case where a feature amount Fa acquired by the feature amount calculation unit 11 is less than the threshold Th1 and the first quantification process is applied, and a quantitative value in a case where the feature amount Fa is greater than or equal to the threshold Th1 and the second quantification process is applied in the first embodiment. FIG. 4 illustrates an example where, for example, 8.2 (%) is obtained as the quantitative value in a case where the feature amount Fa is less than the threshold Th1 and the first quantification process is applied, and for example, 8.0 (%) is obtained as the quantitative value in a case where the feature amount Fa is greater than or equal to the threshold Th1 and the second quantification process is applied. These quantitative values, namely 8.0 (%) and 8.2 (%), are values that match a visual sense in a case where the face is in focus. As described above, according to the present embodiment, it is possible to acquire a quantitative value that matches a visual subjective view and is not an inappropriate value.

FIG. 4 also illustrates, as comparative examples, for example, a quantitative value in a case where the feature amount Fa is less than the threshold Th1 and the second quantification process using the machine learning model is applied, and a quantitative value in a case where the feature amount Fa is greater than or equal to the threshold Th1 and the first quantification process is applied. For example, 20 (%) is obtained as the quantitative value in a case where the feature amount Fa is greater than or equal to the threshold Th1 and the first quantification process is applied, and for example, 6.0 (%) is obtained as the quantitative value in a case where the feature amount Fa is less than the threshold Th1 and the second quantification process is applied. These comparative examples correspond to an example where a feature amount is used as it is as a quantitative value as described in Japanese Patent Laid-Open No. 2020-187656. In the technique described in Japanese Patent Laid-Open No. 2020-187656, there is not information regarding the degree of deviation of a captured image from a reference image as in the present embodiment, and therefore, the quantitative value to be acquired is an inappropriate value. However, it cannot even be determined whether the quantitative value is an inappropriate value. That is, if the feature amount is used as the quantitative value, the quantitative value does not fall within a certain range of values, is a variable value, and requires a variable value in which the degree of deviation from the reference image is a function as a threshold. Thus, a value indicating the degree of deviation results in the feature amount. Thus, the configuration as in the present embodiment is required.

As described above, according to the first embodiment, if the degree of deviation of a target image of quantification from a reference image is small, the first quantification process based on the rule process determined in advance and having high accuracy is performed. If, on the other hand, the degree of deviation of the target image of quantification from the reference image is large, the second quantification process using the machine learning model is performed, whereby it is possible to output a robust quantitative value.

### Variation of First Embodiment

A description is given below taking as an example of a variation of the first embodiment a case where, for example, an evaluation target is a painted surface of a vehicle body or the like, and an orange peel texture inspection for evaluating whether a so-called “orange peel texture” in which a paint film is not smooth on the painted surface and results in an uneven paint texture as in orange peel occurs is performed. An orange peel texture is unevenness that spreads as specific frequency components in a particular region in a two-dimensional direction on a surface because painting is not uniformly performed due to an air current when painting is performed, the influence of surface tension of paint in a drying process, or the like. In the present variation, an example is described where an orange peel texture is quantified from a captured image of a vehicle.

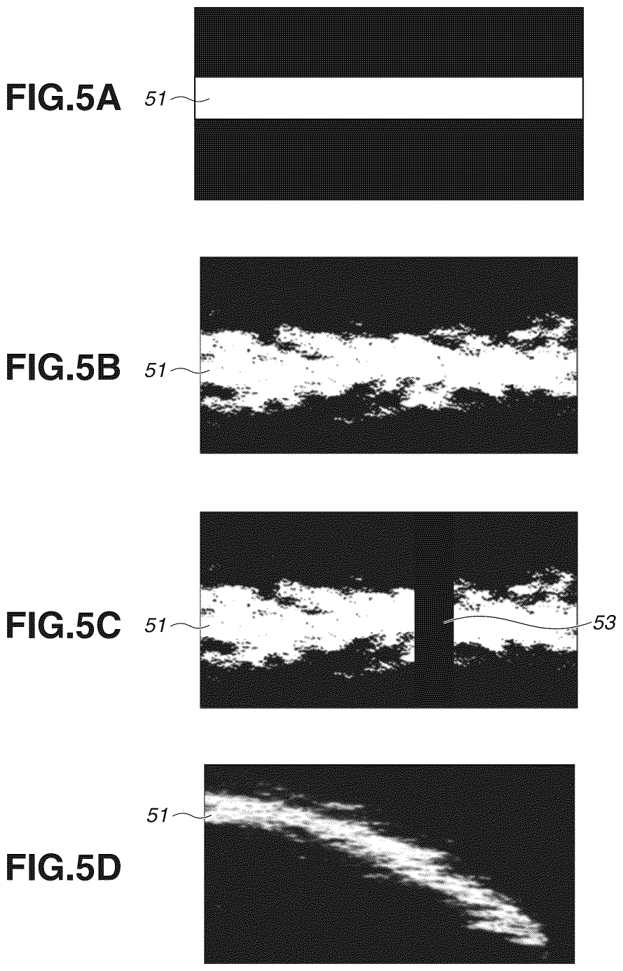

FIGS. 5A to 5D are diagrams illustrating examples of images obtained by capturing a painted surface of a vehicle. FIGS. 5A to 5D illustrate examples of captured images of a side surface of a vehicle body in the state where bar illumination (linear illumination light) unexpectedly appears. In each of FIGS. 5A to 5D, an unexpectedly appearing image 51 is an unexpectedly appearing portion of the bar illumination. FIG. 5A illustrates an example of a captured image obtained by capturing the side surface of the vehicle body in the state where an orange peel texture (gloss unevenness) is hardly present (is very small) in a composition determined in advance. FIG. 5B illustrates an example of a captured image in a case where an orange peel texture occurs. FIG. 5C illustrates an example of a captured image in the state where the composition is shifted when the image is captured, for example, due to a shift in the stop position of the vehicle body, and a gap portion 53 between doors of the vehicle is also captured. FIG. 5D illustrates an example of a captured image captured in the state where the side surface of the vehicle body is slanted when viewed from the camera due to a shift in the stop position of the vehicle body, a shift in the position of the camera, or the like, and the bar illumination is curved by a curved surface of the side surface of the vehicle body or the like.

In the case of the captured image including the unexpectedly appearing image 51 of the bar illumination as illustrated in each of the examples of FIGS. 5A to 5D, a specific high-frequency component is acquired as a quantitative value.

In both examples of the captured images in FIG. 5A in the state where the paint state is excellent and an orange peel texture is hardly present and in FIG. 5B in the state where an orange peel texture occurs, the images are captured in the composition determined in advance with respect to the side surface of the vehicle body. Thus, in both examples of the captured images in FIGS. 5A and 5B, it is possible to evaluate an orange peel texture on the painted surface using a quantitative value acquired by the first quantification process based on the rule process determined in advance.

In contrast, FIG. 5C illustrates the example of the captured image in which the gap portion 53 between doors of the vehicle unexpectedly appears due to a shift in the stop position of the vehicle body when the image is captured. In this case, if the quantitative value acquired by the first quantification process based on the rule process determined in advance is used, an extremely great value is obtained as the evaluation result of an orange peel texture and is an inappropriate value. That is, in a case where an orange peel texture is evaluated, the feature amount calculation unit 11 acquires a feature amount of an unexpectedly appearing region having continuity as in bar illumination, but a feature amount in a case where an unexpectedly appearing region of bar illumination is interrupted by the gap portion 53 is greatly different from the feature amount obtained from the unexpectedly appearing region having continuity. Then, the feature amount obtained from the unexpectedly appearing region interrupted by the gap portion 53 has a high possibility of exceeding the threshold Th1. Thus, in this case, the adoption unit 18 selects the adoption of the second quantification process.

For example, FIG. 5D illustrates the example of the captured image captured such that the bar illumination unexpectedly appears in the state where the bar illumination is curved by a curved surface of the side surface of the vehicle body or the like due to a shift in the stop position of the vehicle body, a shift in the position of the camera, or the like. The feature amount calculation unit 11 acquires a feature amount from information regarding the coordinates in the vertical direction relative to the lateral positions of an unexpectedly appearing region of bar illumination. However, a feature amount in a case where an unexpectedly appearing region of bar illumination is curved as illustrated in FIG. 5D is greatly different from a feature amount obtained from a linear unexpectedly appearing region of bar illumination. Then, the feature amount obtained from the curved unexpectedly appearing region has a high possibility of exceeding the threshold Th1. Thus, in this case, the adoption unit 18 selects the adoption of the second quantification process.

In the second quantification process in a case where the paint state of a vehicle body is evaluated, machine learning using a plurality of images assuming a variety of states as in the examples of FIGS. 5C and 5D is performed in advance, and a machine learning model obtained by the machine learning is used. That is, for example, the machine learning model is a trained model obtained by performing machine learning using images in a variety of states, such as machine learning using an orange peel texture in a portion avoiding a gap between doors, machine learning using orange peel textures of unexpectedly appearing regions that differ in curvature, and the like. Consequently, in the second quantification process, it is possible to acquire an appropriate value as a quantitative value.

### Second Embodiment

In the first embodiment, the quantification unit 13 outputs a quantitative value acquired by either of the first and second quantification processes. In a second embodiment, further, the quantification unit 13 also outputs an adoption result indicating which of the first and second quantification processes is adopted.

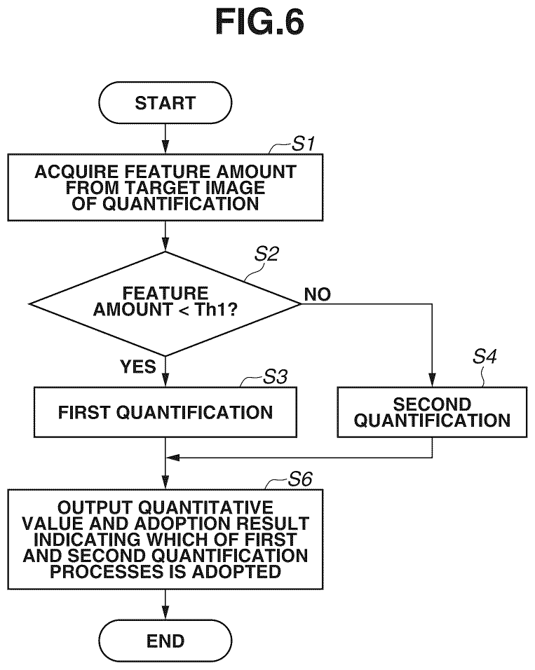

FIG. 6 is a flowchart illustrating the schematic flow of information processing performed by the information processing apparatus 1 according to the second embodiment. In the flowchart of the information processing according to the second embodiment, the processes of steps S1 to S3 are similar to those in the flowchart in FIG. 2. In the second embodiment, after step S3 or S4, the processing proceeds to step S6.

In step S6, the output unit 19 outputs a quantitative value acquired by either of the first and second quantification processes, and an adoption result indicating which of the first and second quantification processes is adopted.

According to the second embodiment, an adoption result indicating which of the first and second quantification processes is adopted is output together with a quantitative value, whereby it is possible to verify the quantitative value. For example, the result of the verification can be used for reference when additional learning of the machine learning model for use in the second quantification process is performed, or can be used as information for finely adjusting the threshold Th1. For example, the result of the verification can also be used for abnormality detection in the information processing apparatus 1, or the like.

### Third Embodiment

Next, as a third embodiment, an example is described where a feature amount is acquired in a region wider than a quantification region as a target for which a quantitative value is acquired.

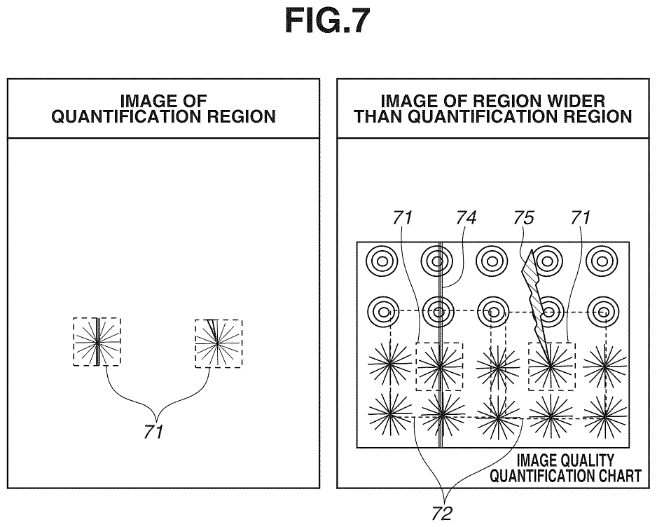

FIG. 7 is a diagram illustrating examples of an image of quantification region 71 as a target for which a quantitative value is acquired and an image of a region (hereinafter, a “wide region 72”) wider than the quantification region 71.

In the third embodiment, a description is given taking as an example a case where a quantitative value for use in evaluating the printing performance of a printer is acquired. In a case where the printing performance of a printer is evaluated, an image quality quantification chart is printed by the printer, and how much the design of the printed chart deviates from an ideal reference design is quantified. Specifically, a quantitative value for use in evaluating the color, the contrast, the graininess, and the thin line reproducibility (how close to an original image a drawn thin line is) of the design of the printed chart is acquired. A captured image of the quantification region 71 in FIG. 7 is an example of an image obtained by the printer printing a chart for evaluating the thin line reproducibility as the image quality quantification chart and by a scanner that is the imaging apparatus 5 reading the chart on the print product as the object 3. The information processing apparatus 1 acquires a feature amount of a chart portion of the thus obtained captured image as a quantification region, and based on the feature amount, selects which of the first and second quantification processes is to be adopted.

For example, in a case where streak unevenness 74 or a scratch 75 exists in the print image of the image quality quantification chart, and if the image of the wide region 72 on the right side of FIG. 7 is used, it is possible to confirm the existence of the streak unevenness 74 or the scratch 75 compared to a case where the image of the quantification region 71 on the left side of FIG. 7 is used. Thus, in the third embodiment, the feature amount calculation unit 11 acquires a feature amount from the image of the wide region 72 having predetermined sizes in the up, down, left, right, and oblique directions of the quantification region 71. Specifically, the feature amount calculation unit 11 counts the number of pixels in which approximately the same pixel values continuously link to each other or the like in the quantification region 71 and the wide region 72 including the quantification region 71, and acquires the counted number of pixels as a single feature amount. Then, based on the feature amount acquired by the feature amount calculation unit 11, the quantification unit 13 performs a quantification process similar to that in the example of the first embodiment. Consequently, the quantification unit 13 can acquire a quantitative value indicating the degree of deviation having high accuracy.

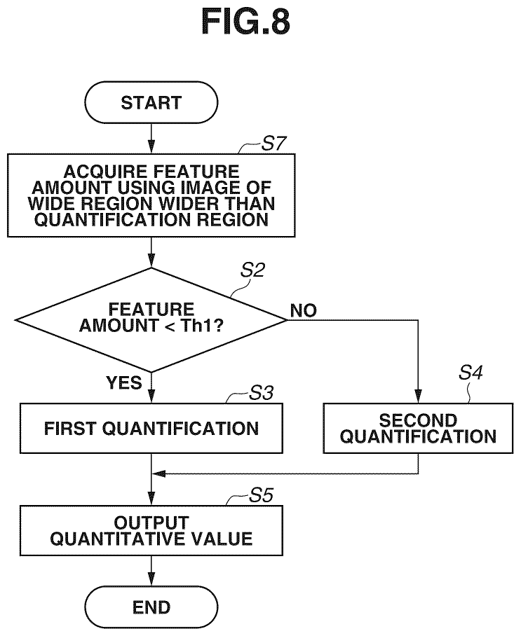

FIG. 8 is a flowchart illustrating the schematic flow of information processing performed by the information processing apparatus 1 according to the third embodiment. In the flowchart of the information processing according to the third embodiment, the processes of steps S2 to S5 are similar to those in the flowchart in FIG. 2, and therefore are not described. In the third embodiment, in step S7 instead of step S1 in FIG. 2, the feature amount calculation unit 11 acquires a feature amount using the image of the wide region 72 wider than the quantification region 71.

### Variation of Third Embodiment

In the example of the third embodiment, an example has been taken where a wide region having predetermined sizes in the up, down, left, right, and oblique directions of the quantification region 71 is the wide region 72. In the following variation of the third embodiment, an example is described where a region including a quantification region and an image of a particular object having a high probability of existing in the use environment is set as a wide region, and a quantification process is performed also using a feature amount acquired from the image of the particular object in the wide region. In the present variation, as an example, a case is taken where the eyes of the face of a person are focused on, for example, as the evaluation of the focusing performance of a camera. In the present variation, a badminton racket is taken as an example of the particular object having a high probability of existing in the use environment, and a description is given taking as an example a case where a string portion of the racket is present as an obstacle in front of the face of the person.

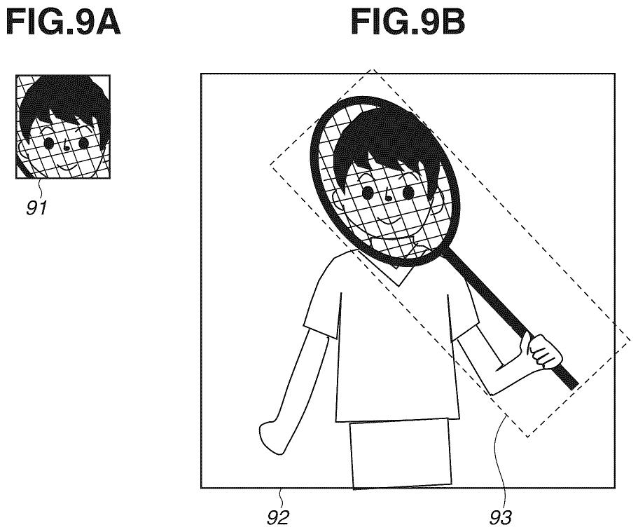

FIG. 9A illustrates the same image as that in FIG. 3B as an example of an image of a quantification region 91 when the focusing performance of the camera is evaluated. FIG. 9B illustrates an example of an image of a wide region 92 wider than the quantification region 91.

In the variation of the third embodiment, the feature amount calculation unit 11 narrows down the particular object having a high probability of existing in the use environment, sets a region including the quantification region 91 and the particular object having a high probability of existing in the use environment as the wide region 92, and acquires a feature amount from the wide region 92. FIGS. 9A and 9B illustrate examples where a badminton racket is assumed as the particular object having a high probability of existing in the use environment.

The feature amount calculation unit 11 searches for an image of a badminton racket as the particular object having a high probability of existing in the use environment, for example, using a machine learning model trained in advance in a captured image of the imaging apparatus 5 that is the camera as the evaluation target of focusing performance. The machine learning model in this example is a machine learning model trained in advance using a plurality of images including a badminton racket and searches for a bounding box 93 containing a badminton racket in the captured image. Then, the feature amount calculation unit 11 acquires a feature amount from an image of the wide region 92 including the quantification region 91 that is an image of the face of a person and the bounding box 93 containing the badminton racket. Consequently, the feature amount calculation unit 11 can acquire the existence probability of a racket, the overlap rate of the coordinates of the strings of a racket and the eyes, and the like as feature amounts. These feature amounts are feature amounts capable of indicating the degree of deviation from the face of the person in the quantification region 91 with high accuracy. Although in the present variation, a machine learning model is used to search for the particular object having a high probability of existing in the use environment, the particular object having a high probability of existing in the use environment may be searched for by a separately determined rule process.

Also in the third embodiment, similarly to the example of the second embodiment, the result of detecting the bounding box 93 surrounding the badminton racket or the like may be output for the purpose of increasing verifiability. Instead of a bounding box, any technique may be used so long as the technique is a recognition technique capable of recognizing a racket or the like from an image. For example, a region of a racket or the like may be identified using semantic segmentation.

### Fourth Embodiment

Next, as a fourth embodiment, an example is described where it is determined whether it is difficult to perform quantification, and if it is determined that it is difficult to perform quantification, a determination result indicating that quantification cannot be performed (quantification is impossible) is output, thereby increasing the reliability of the information processing apparatus 1 that performs a quantification process.

In each of the above embodiments, an example has been taken where the feature amount is compared with the first threshold Th1. In the fourth embodiment, a value greater than the threshold Th1 that is the first threshold is used as an impossibility determination threshold Th0 for determining whether quantification is impossible. The impossibility determination threshold Th0 is a value set in advance by assuming a case where the degree of deviation from the reference is extremely large, and for example, is even beyond the range of application of the machine learning model in the second quantification process, and an incorrect quantitative value is acquired even if the machine learning model is used.

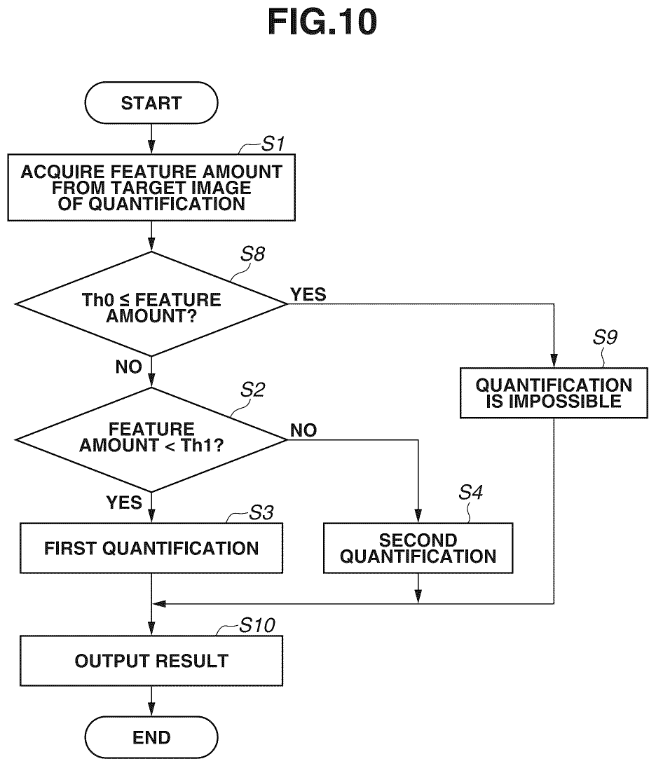

FIG. 10 is a flowchart illustrating the flow of information processing according to the fourth embodiment. In the flowchart in FIG. 10, steps S1 to S4 are similar to the processes of corresponding steps in FIG. 2, and therefore are not described. In the flowchart illustrated in FIG. 10, a branching process in step S8 is provided between steps S1 and S2, step S9 is provided as one of the processes at the branching destinations of step S8, and further, in step S10, the result of step S9 can also be output.

In step S8, the adoption unit 18 determines whether the feature amount is greater than or equal to the impossibility determination threshold (greater than or equal to Th0). Then, if the adoption unit 18 determines that the feature amount is greater than or equal to the impossibility determination threshold Th0 (Yes in step S8), the processing proceeds to step S9. If, on the other hand, the adoption unit 18 determines that the feature amount is less than the impossibility determination threshold Th0 (No in step S8), the processing proceed to step S2 and the subsequent steps.

In step S9, the adoption unit 18 sends a determination result indicating that quantification is impossible to the output unit 19. In the flowchart in FIG. 10, in step S9, the output unit 19 outputs the quantitative value obtained in the quantification process in step S3 or S4, or the determination result indicating that quantification is impossible that is obtained in step S9. For example, the output unit 19 outputs the determination result indicating that quantification is impossible to the display apparatus 7, thereby displaying the determination result on the display apparatus 7.

In the fourth embodiment, if the feature amount is greater than or equal to the impossibility determination threshold Th0, i.e., if the degree of deviation from the reference is extremely large, and an incorrect quantitative value is obtained even if the machine learning model in the second quantification process is used, and the reliability of the information processing apparatus 1 is impaired, a result indicating that quantification is impossible is output. That is, according to the present embodiment, a user or the like is notified that a reliable quantitative value cannot be obtained, whereby it is possible to guarantee the reliability of the information processing apparatus 1.

### Fifth Embodiment

In the first to fourth embodiments, fixed values are used as the threshold Th1 and the impossibility determination threshold Th0. In a fifth embodiment, an example is described where either one or both of the threshold Th1 and the impossibility determination threshold Th0 are updated, for example, according to the situation of additional learning of the machine learning model.

In the fifth embodiment, a plurality of (e.g., 100) images in which, for example, feature amounts are greater than or equal to the impossibility determination threshold Th0 in the fourth embodiment is collected, and a quantitative value is determined by a subjective evaluation by a person (a quantitative value estimated by a subjective evaluation by a person is determined) on each image. Then, additional learning of the machine learning model is performed by supervised learning using these images and the quantitative values determined by the subjective evaluations. Consequently, the result of quantifying an image in which the feature amount is greater than or equal to the impossibility determination threshold Th0 using the machine learning model is close to the quantitative value determined by the subjective evaluation, and the evaluation accuracy improves. As a result, it is possible to update the impossibility determination threshold Th0 to a greater value, and it is also possible to update the threshold Th1, where necessary. As described above, according to the fifth embodiment, it is possible to expand a region where quantification is possible, also including the machine learning model in a case where the feature amount is less than the impossibility determination threshold Th0.

### Sixth Embodiment

Next, as a sixth embodiment, an example is described where a plurality of machine learning models is prepared as the machine learning model for use in the second quantification process, and if the adoption unit 18 determines that the second quantification process is to be adopted, the adoption unit 18 further selects which of the plurality of machine learning models is to be adopted. In the sixth embodiment, using a second threshold (hereinafter, a “threshold Th2”) in addition to the first threshold Th1, the adoption unit 18 selects which of the quantification processes is to be adopted.

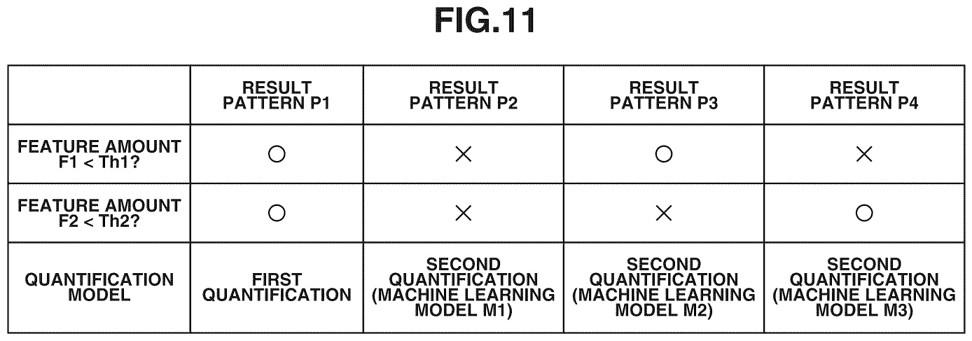

FIG. 11 is a diagram illustrating a table indicating the relationships between a plurality of quantification processes that can be adopted in the sixth embodiment, feature amounts, and thresholds. In the example of FIG. 11, taking two types of feature amounts F1 and F2 as examples of the feature amount acquired by the feature amount calculation unit 11, examples of quantification processes adopted based on the relationships between the feature amounts F1 and F2 and the thresholds Th1 and Th2 are illustrated. In the sixth embodiment, the second threshold Th2 is a value smaller than the impossibility determination threshold Th0 described in the fourth and fifth embodiments and is also a value different from the first threshold Th1. The present embodiment is described taking a case where, when the focusing performance of a camera is evaluated, a grid obstacle, such as the strings of a racket or the like, exists in front of the object 3, and intense light further shines on the object 3 aside from the grid obstacle, whereby a linear luminance saturation value occurs on an image of the object 3.

In a case where a grid obstacle, such as strings or the like, is present in front of the object 3, and a linear luminance saturation value is further present on an image of the object 3, a specific frequency value based on the grid obstacle in an FFT image and the value of a particular pixel on the image based on the linear luminance saturation value are acquired as feature amounts. These feature amounts are merely examples, and any plurality of combinations of amounts acquired as feature amounts may be used. In the present embodiment, the specific frequency value based on the grid obstacle in the FFT image is a first feature amount F1, and the value of the particular pixel on the image based on the linear luminance saturation value is a second feature amount F2. In the present embodiment, the first threshold Th1 is used as a threshold for the first feature amount F1, and the second threshold Th2 is used as a threshold for the second feature amount F2.

Based on the combinations of the first feature amount F1, the second feature amount F2, the threshold Th1, and the threshold Th2, the adoption unit 18 according to the present embodiment selects which of the plurality of quantification processes is to be adopted. The adoption unit 18 adopts any of the first quantification process similar to the above, the second quantification process using a machine learning model M1, the second quantification process using a machine learning model M2, and the second quantification process using a machine learning model M3. That is, as illustrated in FIG. 11, if the first feature amount F1 is less than the threshold Th1 and the second feature amount F2 is less than the threshold Th2 as in a result pattern P1, the adoption unit 18 adopts the first quantification process. For example, if the first feature amount F1 is greater than or equal to the threshold Th1 and the second feature amount F2 is greater than or equal to the threshold Th2 as in a result pattern P2, the adoption unit 18 adopts the second quantification process using the machine learning model M1. For example, if the first feature amount F1 is less than the threshold Th1 and the second feature amount F2 is greater than or equal to the threshold Th2 as in a result pattern P3, the adoption unit 18 adopts the second quantification process using the machine learning model M2. For example, if the first feature amount F1 is greater than or equal to the threshold Th1 and the second feature amount F2 is less than the threshold Th2 as in a result pattern P4, the adoption unit 18 adopts the second quantification process using the machine learning model M3.

As described above, in the example of FIG. 11, there are 2²-1 combinations, i.e., three combinations, as the combinations according to the feature amounts. According to these combinations, the adoption unit 18 selects which of the second quantification process in the three combinations is to be adopted. If N feature amounts are obtained, there are 2^{N}-1 combinations. The machine learning models M1 to M3 are machine learning models generated by classifying captured images of an object according to the combinations of the types of feature amounts to be acquired, and performing learning with respect to each classified image. That is, each machine learning model is a trained model obtained by performing learning according to a change in a feature amount according to the classification of an image and performing learning with the exception of a phenomenon that does not actually occur.

According to the present embodiment, quantification processes are performed by appropriately adopting a plurality of machine learning models trained according to the classifications of images. Thus, it is possible to obtain a quantitative value having accuracy higher than in a case where a machine learning model trained using all images obtained by capturing an object is used.

### Seventh Embodiment

Next, as a seventh embodiment, an example is described where each of the results of the first and second quantification processes is weighted, and the weighted average of the result of the first quantification process and the result of the second quantification process is acquired as a quantitative value. In the seventh embodiment, for example, the adoption unit 18 determines weighting values for the result of the first quantification process and the result of the second quantification process, and the quantification unit 13 outputs a final quantitative value.

In the seventh embodiment, for example, the result of the first quantification process is A0, the result of the second quantification process is A1, a first weight for the result of the first quantification process is W0, and a second weight for the result of the second quantification process is W1. In this case, a final quantitative value A output from the quantification unit 13 can be represented by the following equation (1).

A=W0·A0+W1·A1 equation (1)

In a case where a feature amount is B and the feature amount B is less than or equal to the threshold Th1, and if it is set that W0=1 and W1=0, the quantitative value A in a case where B<Th1 is the same quantitative value as that in a case where the quantification process according to the first embodiment is performed. Further, in a case where Th1<B, and if it is set that W0=1 and W1=0 in the state where the threshold Th1=B, it is possible to obtain continuous values by quantification by the first quantification process and quantification by the second quantification process.

In a case where Th1<B, and if the second weight W1 is changed so that, for example, W1=0 before an obviously inappropriate value is obtained, it is possible to acquire a quantitative value guaranteeing reliability in the entire region of a quantified image in a captured image of an object.

As described above, in the present embodiment, it is possible to determine weights based on a feature amount.

### Eighth Embodiment

Next, as an eighth embodiment, an example is described where, in a case where a plurality of feature amounts is acquired, a function having as many dimensions as the number of the feature amounts or a function having fewer dimensions than the number of the feature amounts is set as a threshold to be used by the adoption unit 18.

For example, in a case where the linearity of a plurality of thresholds for a plurality of feature amounts is low, and if one of the thresholds is moved, there is a case where this affects the other thresholds. In this case, an independent value does not indicate each of the plurality of thresholds, but the plurality of thresholds is represented by a function. For example, if thresholds Th1₁, Th1₂, . . . are present as the plurality of thresholds, the plurality of thresholds is represented by a function such as Th1₁(Th1₂), whereby the plurality of thresholds becomes linear thresholds in a two-dimensional space. Similarly, also in multiple dimensions, the correlations between thresholds are indicated, whereby it is possible to form thresholds in which the accuracy of quantification is maintained at a certain amount.

Embodiments of the present disclosure can also be achieved by the process of supplying a program for achieving one or more functions of the above embodiments to a system or an apparatus via a network or a storage medium, and of causing one or more processors of a computer of the system or the apparatus to read and execute the program. Embodiments of the present disclosure can also be achieved by a circuit (e.g., an application-specific integrated circuit (ASIC)) for achieving the one or more functions.

All the above embodiments illustrate specific examples for carrying out the present disclosure, and therefore the technical scope of the present disclosure should not be interpreted in a limited manner based on these embodiments. That is, embodiments of the present disclosure can be carried out in various ways without departing from the technical ideas or the main features of the present disclosure.

Embodiments of the present disclosure also include the following configurations, method, and storage medium storing a program.

### Configuration 1

An information processing apparatus comprising: at least one processor and at least one memory that is in communication with the at least one processor. The at least one memory stores instructions for causing the at least one processor and the at least one memory to acquire a feature amount indicating a degree of deviation of a captured image of an object from a reference; perform a first quantification process based on a predetermined rule process; perform a second quantification process based on a machine learning model trained using an image having a large degree of deviation from the reference; and adopt either of the first and second quantification processes based on the feature amount.

### Configuration 2

The information processing apparatus according to configuration 1, wherein the at least one memory further stores instructions for causing the at least one processor and the at least one memory to, before the first and second quantification processes are performed, or after the first and second quantification processes are performed, select which of the first and second quantification processes is to be adopted.

### Configuration 3

The information processing apparatus according to configuration 1 or 2, wherein the object is any of a predetermined target object, a predetermined composition, and a predetermined design, and wherein the reference is a reference image of the predetermined target object, a reference image of the predetermined composition, or a reference image of the predetermined design according to the object.

### Configuration 4

The information processing apparatus according to any one of configurations 1 to 3, wherein the at least one memory further stores instructions for causing the at least one processor and the at least one memory acquire the feature amount indicating a difference between an image to which the first quantification process can be applied and an image to which the first quantification process cannot be applied.

### Configuration 5

The information processing apparatus according to any one of configurations 1 to 4, wherein the at least one memory further stores instructions for causing the at least one processor and the at least one memory to output a quantitative value obtained by the first or second quantification process and output an adoption result indicating which of the first and second quantification processes is adopted.

### Configuration 6

The information processing apparatus according to any one of configurations 1 to 5, wherein the at least one memory further stores instructions for causing the at least one processor and the at least one memory to acquire the feature amount from a wide region including a quantification region as a target of a quantification process and wider than the quantification region.

### Configuration 7

The information processing apparatus according to configuration 6, wherein the at least one memory further stores instructions for causing the at least one processor and the at least one memory to acquire the feature amount such that a region including the object and a particular object according to a use environment is the wide region.

### Configuration 8

The information processing apparatus according to any one of configurations 1 to 7, wherein the at least one memory further stores instructions for causing the at least one processor and the at least one memory to, in a case where the feature amount is less than a first threshold, adopt the first quantification process, and in a case where the feature amount is greater than or equal to the first threshold, adopt the second quantification process.

### Configuration 9

The information processing apparatus according to configuration 8, wherein the at least one memory further stores instructions for causing the at least one processor and the at least one memory to use, as the first threshold, a value based on a boundary determined by comparing a quantitative value acquired by the predetermined rule process and a true value.

### Configuration 10

The information processing apparatus according to configuration 8, wherein the at least one memory further stores instructions for causing the at least one processor and the at least one memory to acquire a plurality of feature amounts, and use the first threshold represented by a function having dimensions according to the number of the feature amounts, or a function having fewer dimensions than the number of the feature amounts.

### Configuration 11

The information processing apparatus according to any one of configurations 8 to 10, wherein the at least one memory further stores instructions for causing the at least one processor and the at least one memory to, in a case where the feature amount is greater than or equal to a predetermined impossibility determination threshold, output a determination result indicating the first and second quantification processes are impossible.

### Configuration 12

The information processing apparatus according to configuration 11, wherein the at least one memory further stores instructions for causing the at least one processor and the at least one memory to, according to a situation of additional learning of the machine learning model, update at least either of the first threshold and the impossibility determination threshold.

### Configuration 13

The information processing apparatus according to any one of configurations 1 to 12, wherein the at least one memory further stores a plurality of machine learning models different from each other, and wherein the at least one memory further stores instructions for causing the at least one processor and the at least one memory to, in a case where the second quantification process is adopted, select which of the plurality of machine learning models is to be adopted according to the feature amount.

### Configuration 14

The information processing apparatus according to any one of configurations 1 to 13, wherein the at least one memory further stores instructions for causing the at least one processor and the at least one memory to determine a first weighting value for a result of the first quantification process and a second weighting value for a result of the second quantification process.

### Configuration 15

The information processing apparatus according to configuration 14, wherein the at least one memory further stores instructions for causing the at least one processor and the at least one memory to determine values for calculating a weighted average of the result of the first quantification process and the result of the second quantification process as the first and second weighting values.

### Configuration 16

The information processing apparatus according to configuration 14 or 15, wherein the at least one memory further stores instructions for causing the at least one processor and the at least one memory to determine the first and second weighting values based on the feature amount.

### Method 1

An information processing method comprising: acquiring a feature amount indicating a degree of deviation of a captured image of an object from a reference; performing a first quantification process based on a predetermined rule process; performing a second quantification process based on a machine learning model trained using an image having a large degree of deviation from the reference; and adopting either of the first and second quantification processes based on the feature amount.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-007908, which was filed on Jan. 20, 2025 and which is hereby incorporated by reference herein in its entirety.

What is claimed is:

1. An information processing apparatus comprising:
at least one processor; and
at least one memory that is in communication with the at least one processor, wherein the at least one memory stores instructions for causing the at least one processor and the at least one memory to:
acquire a feature amount indicating a degree of deviation of a captured image of an object from a reference;
perform a first quantification process based on a predetermined rule process;
perform a second quantification process based on a machine learning model trained using an image having a large degree of deviation from the reference; and
adopt either of the first and second quantification processes based on the feature amount.

2. The information processing apparatus according to claim 1, wherein the at least one memory further stores instructions for causing the at least one processor and the at least one memory to, before the first and second quantification processes are performed, or after the first and second quantification processes are performed, select which of the first and second quantification processes is to be adopted.

3. The information processing apparatus according to claim 1,
wherein the object is any of a predetermined target object, a predetermined composition, and a predetermined design, and
wherein the reference is a reference image of the predetermined target object, a reference image of the predetermined composition, or a reference image of the predetermined design according to the object.

4. The information processing apparatus according to claim 1, wherein the at least one memory further stores instructions for causing the at least one processor and the at least one memory to acquire the feature amount indicating a difference between an image to which the first quantification process can be applied and an image to which the first quantification process cannot be applied.

5. The information processing apparatus according to claim 1, wherein the at least one memory further stores instructions for causing the at least one processor and the at least one memory to output a quantitative value obtained by the first or second quantification process, and output an adoption result indicating which of the first and second quantification processes is adopted.

6. The information processing apparatus according to claim 1, wherein the at least one memory further stores instructions for causing the at least one processor and the at least one memory to acquire the feature amount from a wide region including a quantification region as a target of a quantification process and wider than the quantification region.

7. The information processing apparatus according to claim 6, wherein the at least one memory further stores instructions for causing the at least one processor and the at least one memory to acquire the feature amount such that a region including the object and a particular object according to a use environment is the wide region.

8. The information processing apparatus according to claim 1, wherein the at least one memory further stores instructions for causing the at least one processor and the at least one memory to, in a case where the feature amount is less than a first threshold, adopt the first quantification process, and in a case where the feature amount is greater than or equal to the first threshold, adopt the second quantification process.

9. The information processing apparatus according to claim 8, wherein the at least one memory further stores instructions for causing the at least one processor and the at least one memory to use, as the first threshold, a value based on a boundary determined by comparing a quantitative value acquired by the predetermined rule process and a true value.

10. The information processing apparatus according to claim 8, wherein the at least one memory further stores instructions for causing the at least one processor and the at least one memory to:
acquire a plurality of feature amounts, and
use the first threshold represented by a function having dimensions according to the number of the feature amounts, or a function having fewer dimensions than the number of the feature amounts.

11. The information processing apparatus according to claim 8, wherein the at least one memory further stores instructions for causing the at least one processor and the at least one memory to, in a case where the feature amount is greater than or equal to a predetermined impossibility determination threshold, output a determination result indicating the first and second quantification processes are impossible.

12. The information processing apparatus according to claim 11, wherein the at least one memory further stores instructions for causing the at least one processor and the at least one memory to, according to a situation of additional learning of the machine learning model, update at least either of the first threshold and the impossibility determination threshold.

13. The information processing apparatus according to claim 1,
wherein the at least one memory further stores a plurality of machine learning models different from each other, and
wherein the at least one memory further stores instructions for causing the at least one processor and the at least one memory to, in a case where the second quantification process is adopted, select which of the plurality of machine learning models is to be adopted according to the feature amount.

14. The information processing apparatus according to claim 1, wherein the at least one memory further stores instructions for causing the at least one processor and the at least one memory to determine a first weighting value for a result of the first quantification process and a second weighting value for a result of the second quantification process.

15. The information processing apparatus according to claim 14, wherein the at least one memory further stores instructions for causing the at least one processor and the at least one memory to determine values for calculating a weighted average of the result of the first quantification process and the result of the second quantification process as the first and second weighting values.

16. The information processing apparatus according to claim 14, wherein the at least one memory further stores instructions for causing the at least one processor and the at least one memory to determine the first and second weighting values based on the feature amount.

17. An information processing method comprising:
acquiring a feature amount indicating a degree of deviation of a captured image of an object from a reference;
performing a first quantification process based on a predetermined rule process;
performing a second quantification process based on a machine learning model trained using an image having a large degree of deviation from the reference; and
adopting either of the first and second quantification processes based on the feature amount.

18. A storage medium storing computer-executable instructions that, when executed by a computer, cause the computer to:
acquire a feature amount indicating a degree of deviation of a captured image of an object from a reference;
perform a first quantification process based on a predetermined rule process;
perform a second quantification process based on a machine learning model trained using an image having a large degree of deviation from the reference; and
adopt either of the first and second quantification processes based on the feature amount.
